(19) United States
(12) Patent Application Publication
(10) Pub. No.: US 2025/0149609 A1
(43) Pub. Date: May 8, 2025

(54) FUEL CELL

(71) Applicant: L'Air Liquide, Societe Anonyme pour l'Etude et l’Exploitation des Procedes Georges Claude, Paris (FR)

(72) Inventors: Denis SIRAC, Sassenage (FR); Johan ANDRE, Sassenage (FR)

(73) Assignee: L'Air Liquide, Societe Anonyme pour l'Etude et l’Exploitation des Procedes Georges Claude, Paris (FR)

(21) Appl. No.: 18/693,915

(22) PCT Filed: Aug. 30, 2022
(86) PCT No.: PCT/EP2022/074038

§ 371 Date: Mar. 20, 2024

(30) Foreign Application Priority Data
Sep. 20, 2021 (FR) FR 2109861

(51) Int. Cl. H01M 8/2483; H01M 8/0258; H01M 8/0267; H01M 8/04029; H01M 8/1004; H01M 8/241; H01M 8/248

(52) U.S. Cl. CPC H01M 8/2483; H01M 8/0258; H01M 8/0267; H01M 8/04029; H01M 8/1004; H01M 8/241; H01M 8/248

(57) ABSTRACT

A fuel cell comprising a stack of a plurality of cells sandwiched between a first clamping plate and a second clamping plate, the plurality having a first cell at a first end and a last cell at a second end, the stack having a distributor plate and an interface plate interposed between the first clamping plate and the distributor plate, the interface plate having an outer face facing the first clamping plate and an inner face, the interface plate comprising a first dispensing opening, a first section of which opens onto the outer face and a second section of which opens onto the inner face, the first section and the second section having distinct shapes.

### CROSS REFERENCE TO RELATED APPLICATIONS

This application is a § 371 of International PCT Application PCT/EP2022/074038, filed Aug. 30, 2022, which claims the benefit of FR2109861, filed Sep. 20, 2021, both of which are herein incorporated by reference in their entireties.

### FIELD OF THE INVENTION

The present invention relates to a fuel cell, notably a proton-exchange membrane fuel cell (PEMFC), comprising a stack of elementary cells, the cells each comprising an anode plate and a cathode plate sandwiching a membrane electrode assembly (MEA).

### BACKGROUND OF THE INVENTION

The stack of such a fuel cell is sandwiched between two clamping plates to apply a given clamping pressure to the stack, at least one end of the stack comprising an electrically conductive current collection plate electrically connected to the cells of the stack to collect the sum of the electric currents produced by the cells.

Such a compression of the cell stack is often detrimental not just to fuel-cell performance, but also to fuel-cell service life. This is because an inadequately compressed zone exhibits increased electrical contact resistance compared to a more compressed zone. An inadequately compressed zone therefore has degraded operation resulting from greater ohmic losses. Conversely, a cell zone that is relatively over-compressed suffers from accelerated mechanical degradation.

Furthermore, at least one of the ends of the stack has pipework for the circulation of the reactant fluids (air or hydrogen) and for the circulation of the cooling fluid (often a liquid).

The pipework is connected to the fuel cell using sleeves, which are notably substantially cylindrical on the pipework side.

It is important to correctly seal at least the interface at the end of the stack having the pipework for the circulation of fluids, notably between the clamping plate and the electric current collection plate.

It is important that the fluid tightness of the sleeves be dependent neither on the position of penetration of said sleeves nor on the clamping force applied by the clamping plates. Finally, it is important that the overall shape of the sleeves does not impact the fluid tightness of the fuel cell.

### SUMMARY OF THE INVENTION

In certain embodiments, the present invention is intended to efficiently overcome these drawbacks by proposing a proton-exchange membrane fuel cell having a stack of a plurality of cells, the stack being sandwiched between a first clamping plate and a second clamping plate to apply a predetermined clamping pressure to the stack, the plurality of cells having a first cell at a first end of the stack and a last cell at a second end of the stack, each cell of the plurality having an anode plate and a cathode plate sandwiching a membrane electrode assembly, one of the plates of the first cell forming, with one of the plates of another of the cells, a first inter-cell cooling circuit, the other of the plates of the first cell defining a first end plate, one of the plates of the last cell forming, with one of the plates of another of the cells, a last inter-cell cooling circuit, the other of the plates of the last cell defining a last end plate, the fuel cell having a distribution plate having a first electric current collection face intended to face a first electric current collection plate and a distribution face intended to face the cooling face of the first end plate, the distribution plate having a fluid distribution manifold formed through the plate, the fuel cell having an interface plate interposed between the first clamping plate and the distribution plate, the interface plate having an outer face facing the first clamping plate and an inner face opposite the outer face, the interface plate having a first distribution orifice formed through the plate to enable the fluid to pass between the first clamping plate and the distribution plate, the first distribution orifice having a third section defined by a plane extending in the plane containing the interface plate and passing through half the thickness thereof, the first distribution orifice opening through a first section into the outer face and through a second section into the inner face, the shape of the first section being different from the second section and/or different from the third section.

Such a configuration guarantees adequate fluid tightness regardless of the configuration of the fuel cell at the connection thereof to external pipework and regardless of the clamping force applied by the clamping plates to the stack.

According to one configuration, the interface plate and the distribution plate are arranged such that all of the fluid passing through the first distribution orifice enters the distribution manifold of the distribution plate.

According to one configuration, the surface area of the first section is less than the surface area of the second section and/or the surface area of the first section is less than the surface area of the third section.

Such a configuration helps to limit the external size of the fuel cell while enabling optimisation of the circulation of the fluid inside the fuel cell.

According to one configuration, the surface area of the first section is less than 90% of the surface area of the second section, notably less than 70% of the surface area of the second section, for example less than 55% of the surface area of the second section.

According to one configuration, the surface area of the first section is less than 90% of the surface area of the third section, notably less than 70% of the surface area of the third section, for example less than 55% of the surface area of the third section.

Such a configuration ensures a uniform flow of the fluid from the ingress thereof into the first distribution orifice up to the distribution plate, and therefore into the cells of the fuel cell.

According to one configuration, the first section is substantially disk-shaped.

According to one configuration, the second section and/or the third section has at least one side including a line segment.

According to one configuration, the second section has the same shape as the section of the distribution manifold so that the distribution manifold and the first distribution orifice can be aligned edge-to-edge.

According to one configuration, the section of the distribution manifold is considered in a plane lying in the plane of the distribution plate, notably at the face on the interface plate side.

According to one configuration, the fuel cell has at least one sleeve for connecting the fuel cell to pipework for the circulation of a fluid.

According to one configuration, the sleeve is substantially cylindrical, notably at the connection to the pipework.

According to one configuration, the sleeve has a first end, the section of which is substantially the same shape as the first section, enabling the sleeve to fit into the first distribution orifice.

According to one configuration, the first end of the sleeve or the first distribution orifice has a first annular groove for interposing a seal.

According to one configuration, the fuel cell has a seal, notably an O-ring or a lip seal, interposed between the first orifice and the sleeve to ensure fluid tightness.

According to one configuration, the seal is inserted in the first annular groove.

According to one configuration, the sleeve has a first annular shoulder to enable the sleeve to be fitted onto the interface plate.

According to one configuration, the first clamping plate has a second shoulder designed to fit onto the first shoulder, holding the sleeve in place while the fuel cell is being assembled.

According to one embodiment, the fuel cell has a first flat seal interposed between the distribution plate and the interface plate.

According to one embodiment, the fuel cell does not have an O-ring arranged on either side of the first flat seal to provide a fluid tight seal.

According to one embodiment, the first electric current collection face has a first boss for receiving the first collection plate, such that the distribution plate and the first collection plate together form a flat face to come into contact with the first flat seal.

According to one embodiment, the first flat seal has at least a second distribution orifice to enable the fluid to pass between the interface plate and the distribution plate.

According to one embodiment, the first collection plate has a tongue projecting from the plane of the first collection plate and the first flat seal has a slot enabling the tongue to pass through the first flat seal.

According to one embodiment, the fuel cell has at least one tie rod for applying the clamping pressure to the stack, the first flat seal having at least one through-hole for passage of the tie rod.

According to one embodiment, the interface plate has a through-hole for passage of the tie rod.

According to one embodiment, the second section has the same shape as the second distribution orifice so that the first distribution orifice and the second distribution orifice can be aligned edge-to-edge.

According to one embodiment, the distribution plate is fastened to the first end plate, notably by welding.

In a variant, the distribution plate and the first end plate form a single piece manufactured by molding and/or machining and/or hydroforming and/or pressing and/or three-dimensional printing.

Such fastening improves the fluid tight seal.

According to one embodiment, the distribution manifold is arranged such that all of the fluid entering the distribution manifold passes through the thickness of the distribution plate to distribute the fluid in the first cell.

According to one embodiment, the distribution plate has six distribution manifolds, notably to distribute or collect a fuel, an oxidant and a cooling fluid.

According to one embodiment, the first electric current collection face and/or the first interface plate has an annular lip formed about the distribution manifold so as to clamp the first flat seal and provide a fluid tight seal.

According to one embodiment, the annular lip is formed about the entire perimeter of the distribution manifold.

According to one embodiment, the annular lip projects from the plane of the plate.

According to one embodiment, the annular lip is integral with the first clamping plate.

In a variant, the annular lip is integral with the distribution plate.

According to one embodiment, one of either the first electric current collection face or the first clamping plate has an annular lip formed about the distribution manifold and the other of either the first electric current collection face or the first clamping plate has a second annular groove, so as to clamp the first flat seal and provide a fluid tight seal.

According to one embodiment, the second annular groove and the annular lip are arranged such that the lip faces the second groove in the absence of the flat seal.

This arrangement enables the flat seal to be clamped, forming two folds in said flat seal.

According to one embodiment, the first flat seal, when unstressed, has a substantially constant thickness over the entire surface thereof.

According to one embodiment, the first flat seal has no boss.

According to one embodiment, the first flat seal has a flat face, the surface area of which is at least equal to 80% of the surface area of the face of the first end plate facing the first flat seal.

According to one embodiment, the first flat seal has a flat face, the surface area of which is at least equal to 80% of the surface area of the face of the first clamping plate.

According to one embodiment, the first flat seal is electrically insulating.

According to one embodiment, the first flat seal is made of a silicone-, elastomer-, or ethylene-propylene-diene-monomer-(EPDM) based material.

According to one embodiment, the first flat seal is in contact with at least a portion of the first collection plate and is in contact with at least a portion of the distribution plate.

According to one embodiment, the fuel cell does not have an O-ring arranged on either side of the first flat seal to provide a fluid tight seal.

According to one embodiment, the first electric current collection face has a first boss for receiving the first collection plate, such that the distribution plate and the first collection plate together form a flat face to come into contact with the first flat seal.

According to one embodiment, the first flat seal has at least one orifice to enable the fluid to pass between the first clamping plate and the distribution plate.

According to one embodiment, the first collection plate has a tongue projecting from the plane of the first collection plate and the first flat seal has a slot enabling the tongue to pass through the first flat seal.

According to one embodiment, the slot is distinct from the orifice.

According to one embodiment, the fuel cell has at least one tie rod for applying the clamping pressure to the stack.

According to one embodiment, the first flat seal has at least one through-hole for passage of the tie rod.

According to one embodiment, the first collection plate is electrically connected to the distribution plate.

According to one embodiment, each anode plate or cathode plate comprises a reactive face and a cooling face opposite one another, the reactive face of each plate being intended to face the membrane electrode assembly and being provided with relief elements and hollows forming a reactant circuit for the circulation of a reactant fluid, the cooling face of the cathode plate of at least one of the cells being intended to face the cooling face of the anode plate of another of the cells, defining between them relief elements and hollows to form an inter-cell cooling circuit for the circulation of a cooling fluid.

According to one embodiment, each cathode plate or anode plate has a reactant inlet manifold formed through the plate and in fluidic communication with the reactant circuit, a reactant outlet manifold formed through the plate and in fluidic communication with the reactant circuit, a cooling fluid inlet manifold formed through the plate, and a cooling fluid outlet manifold formed through the plate.

According to one embodiment, the fuel cell has a closure plate comprising a second electric current collection face intended to face a second electric current collection plate and a closure face fastened to the cooling face of the last end plate, the closure face and the cooling face of the last end plate defining between them relief elements and hollows to form a last cooling circuit for the circulation of the cooling fluid.

According to one embodiment, the fuel cell has a second flat seal interposed between the second collection plate and the second clamping plate.

According to one embodiment, the second flat seal, when unstressed, has a constant thickness over the entire surface thereof.

According to one embodiment, the second flat seal is electrically insulating.

According to one embodiment, the second flat seal has a flat face, the surface area of which is at least equal to 80% of the surface area of one of the faces of the second clamping plate.

According to one embodiment, the second flat seal has a flat face, the surface area of which is at least equal to 80% of the surface area of one of the faces of the closure plate.

According to one embodiment, the second electric current collection face has a second boss for receiving the second collection plate, such that the closure plate and the second collection plate form a flat face to come into contact with the second flat seal.

### BRIEF DESCRIPTION OF THE DRAWINGS

The invention will be understood better from reading the following description and from studying the figures. These figures are given only to illustrate, and in no way to limit, the invention.

FIG. 1 is a schematic representation, in section, of a fuel cell according to the invention,

FIG. 2 is a schematic representation in elevation and in cross section of a detail of the fuel cell from FIG. 1, and

FIG. 3 is a schematic representation, in elevation, of the fuel cell from FIG. 1.

### DETAILED DESCRIPTION OF THE INVENTION

Those elements which are identical, similar or analogous keep the same reference from one figure to the next.

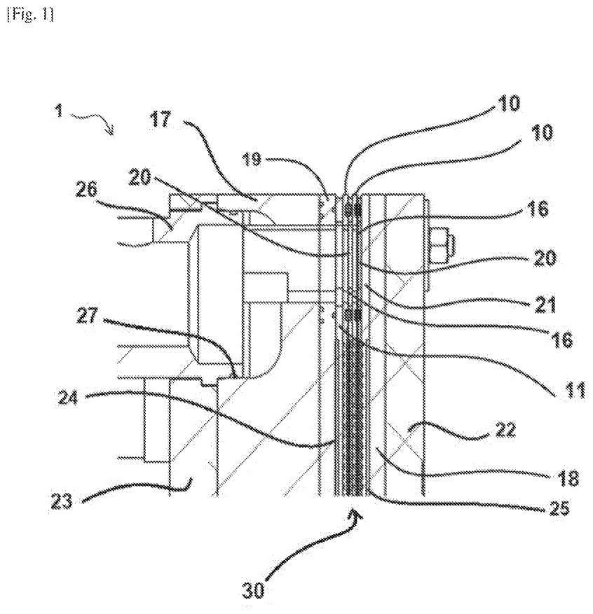

As shown in FIG. 1, a proton-exchange membrane fuel cell 1 has a stack of a plurality of cells 30, the stack being sandwiched between a first clamping plate 23 and a second clamping plate 22 to apply a predetermined clamping pressure to the stack.

The plurality of cells 30 has a first cell 30 at a first end of the stack and a last cell 30 at a second end of the stack.

Each cell 30 of the plurality has an anode plate 10 and a cathode plate 20 sandwiching a membrane electrode assembly 16, one of the plates 10, 20 of the first cell 30 forming, with one of the plates 10, 20 of another of the cells 30, a first inter-cell cooling circuit 15, the other of the plates 10, 20 of the first cell 30 defining a first end plate, one of the plates 10, 20 of the last cell 30 forming, with one of the plates 10, 20 of another of the cells 30, a last inter-cell cooling circuit 15, the other of the plates 10, 20 of the last cell 30 defining a last end plate.

The fuel cell 1 has a distribution plate 11 comprising a first electric current collection face intended to face a first electric current collection plate 24 and a distribution face intended to face the cooling face of the first end plate.

The fuel cell 1 has an interface plate 17 interposed between the first clamping plate 23 and the distribution plate 11, the interface plate 17 having an outer face facing the first clamping plate 23 and an inner face opposite the outer face. The interface plate 17 has a first distribution orifice formed through the plate to enable the fluid to pass between the first clamping plate 23 and the distribution plate 11.

The first orifice has a third section defined by a plane extending in the plane containing the interface plate 17 and passing through half the thickness thereof.

The first distribution orifice opens through a first section into the outer face and through a second section into the inner face.

The first section and the second section have different shapes.

The first section and the third section have different shapes.

In this case, the difference between the shapes is not considered to be caused by tolerances normal in the industry.

In one example embodiment, the first section is defined substantially by a circle or an oval. The second and/or third section is defined substantially by a rectangle or a trapezoid.

The fuel cell 1 has a first flat seal 19 interposed between the distribution plate 11 and the interface plate 17, the distribution plate 11 having at least one distribution manifold for a fluid formed through the plate.

The first electric current collection face and/or the interface plate 17 has an annular lip formed about the distribution manifold so as to clamp the first flat seal 19 and provide a fluid tight seal.

The first electric current collection face has a first boss for receiving the first collection plate 24, such that the distribution plate 11 and the first collection plate 24 together form a flat face to come into contact with the first flat seal 19.

The first flat seal 19 has at least a second orifice to enable the fluid to pass between the first clamping plate 23 and the distribution plate 11.

The first collection plate 24 has a tongue projecting from the plane of the first collection plate 24.

The first flat seal 19 has a slot to enable the tongue to pass through the first flat seal 19.

The interface plate 17 has a slot to enable the tongue to pass through the interface plate 17.

The fuel cell has at least one tie rod for applying the clamping pressure to the stack.

The first flat seal 19 has at least one through-hole for passage of the tie rod.

As shown in FIG. 1, the fuel cell 1 has a closure plate 21 comprising a second electric current collection face intended to face a second electric current collection plate 25 and a closure face fastened to the cooling face of the last end plate, the closure face and the cooling face of the last end plate defining between them relief elements and hollows to form a last cooling circuit for the circulation of the cooling fluid.

The fuel cell 1 has a second flat seal 18 interposed between the second collection plate 25 and the second clamping plate 22.

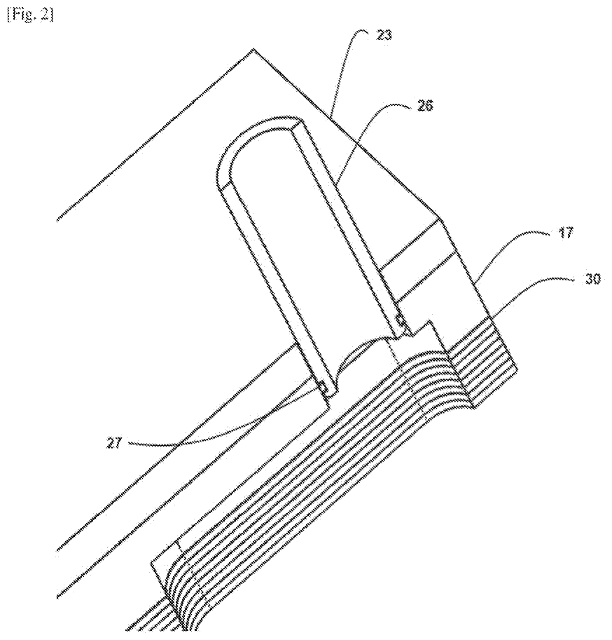

As shown in FIG. 2, the fuel cell 1 has at least one sleeve 26 for connecting the fuel cell to pipework for the circulation of a fluid.

The sleeve 26 is substantially cylindrical, notably at the connection to the pipework.

The sleeve 26 has a first end, the section of which is substantially the same shape as the first section, enabling the sleeve 26 to fit into the first distribution orifice.

The first end of the sleeve 26 or the first distribution orifice has a first annular groove 27 for interposing a seal.

The fuel cell 1 has a seal, notably an O-ring or a lip seal, interposed between the first orifice and the sleeve 26 to ensure fluid tightness.

The seal is inserted in the first annular groove 27.

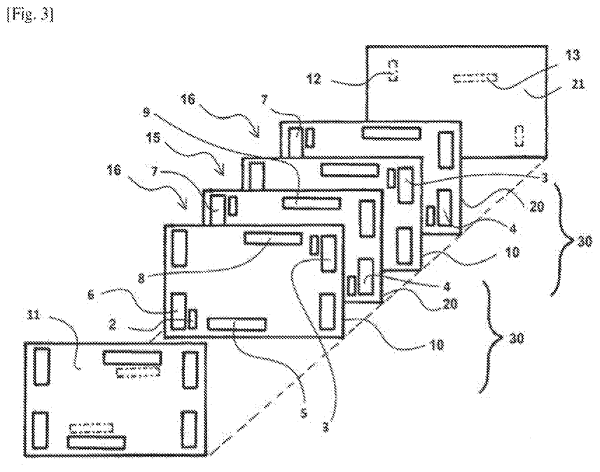

FIG. 3 shows the fuel cell 1 in elevation, before assembly.

As shown in FIG. 3, each plate 10, 20 has:
a reactant inlet manifold 3, 4 formed through the plate 10, 20 and in fluidic communication with the reactant circuit via a first aperture 2 formed through the plate 10, 20,
a reactant outlet manifold 6, 7 formed through the plate 10, 20 and in fluidic communication with the reactant circuit via a second aperture 2 formed through the plate 10, 20,
a cooling fluid inlet manifold 5 formed through the plate 10, 20,
a cooling fluid outlet manifold 8, 9 formed through the plate 10, 20,
at least two orifices formed through the plate 10, 20, each orifice being arranged to allow fluidic communication through the plate 10, 20 only, without being in fluidic communication with the reactant circuit.

The reactant inlet manifold 3 of an anode plate 10 is in fluidic communication with one of the orifices of a cathode plate 20 and the reactant outlet manifold 6 of the anode plate 10 is in fluidic communication with another of the orifices of the cathode plate 20.

The reactant inlet manifold 3 of a cathode plate 20 is in fluidic communication with one of the orifices of an anode plate 10 and the reactant outlet manifold 6 of the cathode plate 20 is in fluidic communication with another of the orifices of the anode plate 10.

Thus, the stack allows distribution of the reactant fluid intended for the anode plates 10 and distribution of the reactant fluid intended for the cathode plates 20, forming two independent circuits.

The closure face of the closure plate 21 has a reactant passage 12, 13 formed by relief elements and hollows, to allow fluidic communication between the reactant inlet manifold 3, 4 and the reactant circuit or to allow fluidic communication between the reactant outlet manifold 6, 7 and the reactant circuit.

The closure face of the closure plate 21 has a cooling passage 13 formed by relief elements and hollows, to allow fluidic communication between the cooling fluid inlet manifold 5 and the cooling circuit, or to allow fluidic communication between the cooling fluid outlet manifold 8, 9 and the cooling circuit.

The reactant passage 12, 13 and the cooling passage 13 may be arranged on the closure face, on the last end plate, or on both of these.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

1-11. (canceled)

12. A proton-exchange membrane fuel cell comprising:
a stack of a plurality of cells, the stack being sandwiched between a first clamping plate and a second clamping plate that are configured to apply a predetermined clamping pressure to the stack, the plurality of cells further comprising:
a first cell at a first end of the stack and a last cell at a second end of the stack, each cell of the plurality having an anode plate and a cathode plate sandwiching a membrane electrode assembly, one of the plates of the first cell forming, with one of the plates of another of the cells, a first inter-cell cooling circuit, the other of the plates of the first cell defining a first end plate, one of the plates of the last cell forming, with one of the plates of another of the cells, a last inter-cell cooling circuit, the other of the plates of the last cell defining a last end plate;
a distribution plate having a first electric current collection face intended to face a first electric current collection plate and a distribution face intended to face the cooling face of the first end plate, the distribution plate having a fluid distribution manifold formed through the plate; and
an interface plate interposed between the first clamping plate and the distribution plate, the interface plate having an outer face facing the first clamping plate and an inner face opposite the outer face, the interface plate having a first distribution orifice formed through the plate to enable the fluid to pass between the first clamping plate and the distribution plate, the first distribution orifice having a third section defined by a plane extending in the plane containing the interface plate and passing through half the thickness thereof, the first distribution orifice opening through a first section into the outer face and through a second section into the inner face, the shape of the first section being different from the second section and/or different from the third section.

13. The fuel cell of claim 12, the interface plate and the distribution plate being arranged such that all of the fluid passing through the first distribution orifice enters the distribution manifold of the distribution plate.

14. The fuel cell as claimed in claim 12, wherein the surface area of the first section being less than 90% of the surface area of the third section, notably less than 70% of the surface area of the third section, for example less than 55% of the surface area of the third section.

15. The fuel cell as claimed in claim 12, wherein the first section is substantially disk-shaped.

16. The fuel cell as claimed in claim 12, wherein the second section and/or the third section comprise at least one side including a line segment.

17. The fuel cell as claimed in claim 12, wherein the second section has the same shape as the section of the distribution manifold so that the distribution manifold and the first distribution orifice can be aligned edge-to-edge.

18. The fuel cell as claimed in claim 12, wherein the fuel cell comprises a first flat seal interposed between the distribution plate and the interface plate.

19. The fuel cell as claimed in claim 18, wherein the fuel cell comprises an absence of an O-ring arranged on either side of the first flat seal to provide a fluid tight seal.

20. The fuel cell as claimed in claim 18, wherein the first electric current collection face comprises a first boss for receiving the first collection plate, such that the distribution plate and the first collection plate together form a flat face to come into contact with the first flat seal.

21. The fuel cell as claimed in claim 18, wherein the first flat seal comprises at least a second distribution orifice to enable the fluid to pass between the interface plate and the distribution plate.

22. The fuel cell as claimed in claim 18, wherein the first collection plate comprises a tongue projecting from the plane of the first collection plate and the first flat seal having a slot enabling the tongue to pass through the first flat seal.
